(19) United States
(12) Patent Application Publication
(10) Pub. No.: US 2016/0212448 A1
(43) Pub. Date: Jul. 21, 2016

(54) METHOD AND DEVICE FOR VIDEO ENCODING OR DECODING BASED ON DICTIONARY DATABASE

(71) Applicant: PEKING UNIVERSITY SHENZHEN GRADUATE SCHOOL, Shenzhen (CN)

(72) Inventors: Ronggang WANG, Shenzhen (CN); Yang ZHAO, Shenzhen (CN); Zhenyu WANG, Shenzhen (CN); Wen GAO, Shenzhen (CN); Wenmin WANG, Shenzhen (CN); Shengfu DONG, Shenzhen (CN); Tiejun HUANG, Shenzhen (CN); Siwei MA, Shenzhen (CN)

(21) Appl. No.: 15/081,930

(22) Filed: Mar. 27, 2016

Related U.S. Application Data
(63) Continuation-in-part of application No. PCT/CN2014/078611, filed on May 28, 2014.

(51) Int. Cl. H04N 19/86; H04N 19/503; H04N 19/176; G06F 17/30; H04N 19/136; H04N 19/124; H04N 19/119; H04N 19/44; H04N 19/46; H04N 19/154

(52) U.S. Cl. CPC H04N 19/86; H04N 19/46; H04N 19/503; H04N 19/176; H04N 19/154; H04N 19/136; H04N 19/124; H04N 19/119; H04N 19/44; G06F 17/30784

(57) ABSTRACT

A method for video encoding based on a dictionary database, the method including: 1) dividing a current image frame to be encoded in a video stream into a plurality of image blocks; 2) recovering encoding distortion information of a decoded and reconstructed image of a previous frame of the current image frame using a texture dictionary database to obtain an image with recovered encoding distortion information, and performing temporal prediction using the image with the recovered encoding distortion information as a reference image to obtain prediction blocks of image blocks to be encoded; in which, the texture dictionary database includes: clear image dictionaries and distorted image dictionaries corresponding to the clear image dictionaries; and 3) performing subtraction between the image blocks to be encoded and the prediction blocks to obtain residual blocks, and processing the residual blocks to obtain a video bit stream.

### CROSS-REFERENCE TO RELATED APPLICATIONS

This application is a continuation-in-part of International Patent Application No. PCT/CN2014/078611 with an international filing date of May 28, 2014, designating the United States, now pending, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to a method and a device for video encoding or decoding based on a dictionary database.

2. Description of the Related Art

Typically, a codec utilizes a decoded and reconstructed image of a previous frame of the current image frame as a reference image to perform the temporal prediction to obtain the prediction block of the image block to be encoded. However, quantization noise exists in the decoded and reconstructed image, which leads to the loss of the high frequency information and, therefore, decreases the prediction efficiency.

### SUMMARY OF THE INVENTION

In view of the above-described problems, it is one objective of the invention to provide a method and a device for video encoding or decoding based on a dictionary database. A texture dictionary database is utilized to recover the encoding distortion information of the reference image which used to predict the image blocks to be encoded/decoded, so that the prediction blocks of the image blocks to be encoded/decoded are much accurate, and the encoding/decoding efficiency is improved.

To achieve the above objective, in accordance with one embodiment of the invention, there is provided a method for video encoding based on a dictionary database. The method comprises:

1) dividing a current image frame to be encoded in a video stream into a plurality of image blocks;

2) recovering encoding distortion information of a decoded and reconstructed image of a previous frame of the current image frame using a texture dictionary database to obtain an image with recovered encoding distortion information, and performing temporal prediction using the image with the recovered encoding distortion information as a reference image to obtain prediction blocks of image blocks to be encoded; in which the texture dictionary database comprises: clear image dictionaries and distorted image dictionaries corresponding to the clear image dictionaries; and

3) performing subtraction between the image blocks to be encoded and the prediction blocks to obtain residual blocks, and processing the residual blocks to obtain a video bit stream.

In accordance with another embodiment of the invention, there is provided a method for video decoding based on a dictionary database. The method comprises:

1) processing an acquired video bit stream to obtain residual blocks of image blocks to be decoded of a current image frame to be decoded;

2) recovering encoding distortion information of a decoded and reconstructed image of a previous frame of the current image frame using a texture dictionary database to obtain an image with recovered encoding distortion information, and performing temporal prediction using the image with the recovered encoding distortion information as a reference image to obtain prediction blocks of image blocks to be decoded; in which the texture dictionary database comprises: clear image dictionaries and distorted image dictionaries corresponding to the clear image dictionaries; and

3) adding the prediction blocks to the corresponding residual blocks to obtain the decoded reconstructed blocks of the image blocks to be decoded.

In accordance with another embodiment of the invention, there is provided a device for video encoding based on a dictionary database. The device comprises:

a) an image block dividing unit configured to divide a current image frame to be encoded in a video stream into a plurality of image blocks;

b) an image enhancing unit configured to recover encoding distortion information of a decoded and reconstructed image of a previous frame of the current image frame using a texture dictionary database to obtain an image with recovered encoding distortion information, and adopt the image with the recovered encoding distortion information as a reference image; wherein the texture dictionary database comprises: clear image dictionaries and distorted image dictionaries corresponding to the clear image dictionaries;

c) a prediction unit configured to perform temporal prediction according to the reference image to obtain prediction blocks of image blocks to be encoded;

d) a residual block acquiring unit configured to perform subtraction between the image blocks to be encoded and the prediction blocks to obtain residual blocks; and

e) a processing unit configured to process the residual blocks to obtain a video bit stream.

In accordance with another embodiment of the invention, there is provided a device for video decoding based on a dictionary database. The device comprises:

a) a processing unit configured to process an acquired video bit stream to obtain residual blocks of image blocks to be decoded of a current image frame to be decoded;

b) an image enhancing unit configured to recover encoding distortion information of a decoded and reconstructed image of a previous frame of the current image frame using a texture dictionary database to obtain an image with recovered encoding distortion information, and adopt the image with the recovered encoding distortion information as a reference image; wherein the texture dictionary database comprises: clear image dictionaries and distorted image dictionaries corresponding to the clear image dictionaries;

c) a prediction unit configured to perform temporal prediction according to the reference image to obtain prediction blocks of image blocks to be decoded; and

d) an output unit configured to add the prediction blocks to the corresponding residual blocks to obtain the decoded reconstructed blocks of the image blocks to be decoded.

Advantages of a method and a device for video encoding or decoding based on a dictionary database according to embodiments of the invention are summarized as follows:

In the method and the device for video encoding, the encoding distortion information of the decoded and reconstructed image in the previous frame of the current image frame is recovered using the texture dictionary database, and the temporal prediction is then performed using the image with the recovered encoding distortion information as the reference image to obtain the prediction blocks of the image blocks to be encoded. The encoding method and device are capable of recovering the encoding distortion information of the reference image to make the prediction blocks of the image blocks to be encoded more accurate, thus improving the encoding efficiency.

In the method and the device for video decoding, the encoding distortion information of the decoded and reconstructed image in the previous frame of the current image frame is recovered using the texture dictionary database, and the temporal prediction is then performed using the image with the recovered encoding distortion information as the reference image to obtain the prediction blocks of the image blocks to be decoded. The decoding method and device are capable of recovering the encoding distortion information of the reference image to make the prediction blocks of the image blocks to be decoded more accurate, thus improving the decoding efficiency.

### BRIEF DESCRIPTION OF THE DRAWINGS

The invention is described hereinbelow with reference to the accompanying drawings, in which:

FIG. 1 is a flow chart of a method for video encoding based on a dictionary database in accordance with one embodiment of the invention;

FIG. 2 is a block diagram of a method for video encoding based on a dictionary database in accordance with one embodiment of the invention;

FIG. 3A-3d are structure diagrams of feature extraction of a local texture structure of an image block in accordance with one embodiment of the invention;

FIG. 4 is a structure diagram of a device for video encoding based on a dictionary database in accordance with one embodiment of the invention;

FIG. 5 is a flow chart of a method for video decoding based on a dictionary database in accordance with one embodiment of the invention;

FIG. 6 is a block diagram of a method for video decoding based on a dictionary database in accordance with one embodiment of the invention; and

FIG. 7 is a structure diagram of a device for video decoding based on a dictionary database in accordance with one embodiment of the invention.

### DETAILED DESCRIPTION OF THE EMBODIMENTS

For further illustrating the invention, experiments detailing a method and a device for video encoding or decoding based on a dictionary database are described below. It should be noted that the following examples are intended to describe and not to limit the invention.

### Example 1

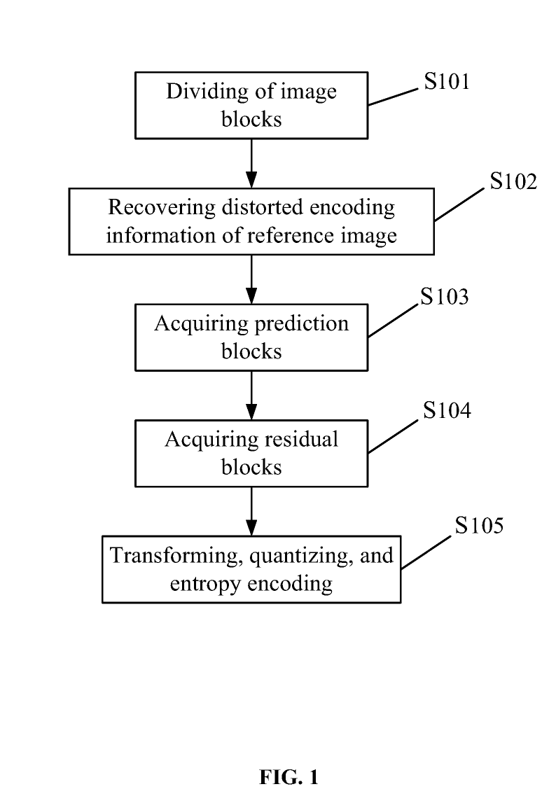

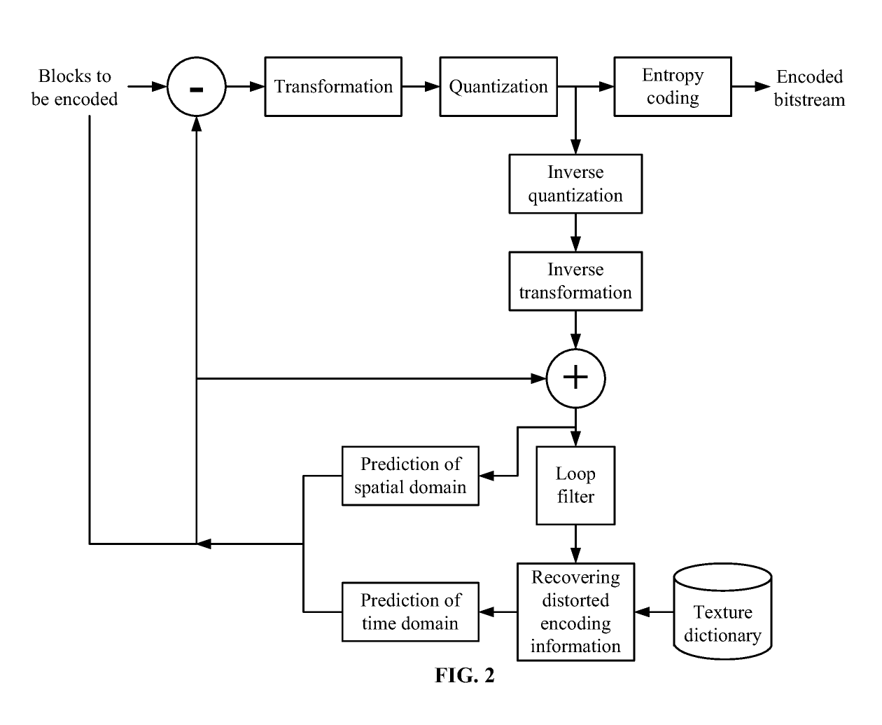

As shown in FIGS. 1-2, FIG. 1 is a flow chart of a method for video encoding based on a dictionary database in accordance with one embodiment of the invention. FIG. 2 is a block diagram of a method for video encoding based on a dictionary database in accordance with one embodiment of the invention. A method for video encoding based on a dictionary database comprises the following steps:

S101: dividing a current image frame to be encoded in a video stream into a plurality of image blocks;

S102: recovering encoding distortion information of a decoded and reconstructed image of a previous frame of the current image frame using a texture dictionary database to obtain an image with recovered encoding distortion information, and adopting the image with the recovered encoding distortion information as a reference image, in which the encoding distortion information comprises high frequency information.

In one specific embodiment, the texture dictionary can be obtained by pre-training, and the pre-training of the texture dictionary comprises the following steps: selecting local blocks in a clear image; selecting corresponding local blocks in a quantizing distorted image of the clear image; and extracting feature pairs of the local blocks in the clear image and the corresponding local blocks in the quantizing distorted image so as to form clear image dictionaries Dₕ and distorted image dictionaries Dₗ.

In the feature pairs of the local blocks, features of the local blocks comprise: local gray differences, gradient values, local texture structures, and texture structure information of neighboring image blocks, etc. The edge and texture features of the local blocks can be described by combining the above features.

The feature of the local texture structure is illustrated hereinbelow.

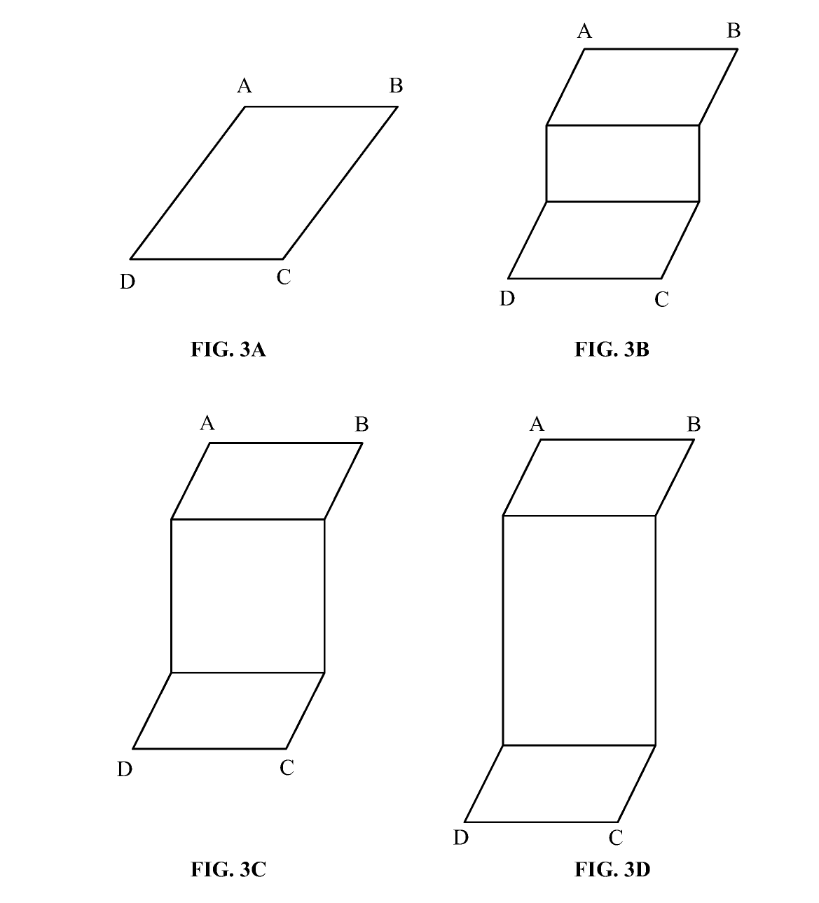

As shown in FIGS. 3A, 3B, and 3C, A, B, C, and D represent four locally neighboring pixels, and a height of each pixel reflects a gray value thereof. FIG. 3A denotes a flat local region, and two pixels (A, B) have relatively high gray values. Herein LBS-Geometry (LBS_G) is defined in order to discriminate the difference in the geometry structures, and equation for calculating LBS-Geometry (LBS_G) is as follows:

$$LBS\_G = {\sum }_{P = 1}^{4} S ( {g}_{p} - {g}_{mean} ) {2}^{p - 1} , S ( x ) = \{ \begin{matrix}1 , & x \geq 0 \\ 0 , & else\end{matrix} \qquad ( 1 )$$

in which, gₚ represents the gray value of a p-th pixel in a local region, and gₘₑₐₙ represents a mean value of local gray values.

As shown in FIGS. 3B, 3C, and 3D, although the three local structures have the same LBS_G code, they still belong to different local modes because of the difference in the degree of the gray difference. Thus, LBS-Difference (LBS_D) is defined in this example in order to represent the degree of local gray difference, and the following equation is obtained:

LBS_D=Σ_{P=1}⁴S(dₚ−d_{global})2^{p-1},dₚ=|gₚ−gₘₑₐₙ| (2)

in which, d_{global} represents a mean value of all the local gray differences in an entire image.

The complete description of the local binary structure (LBS) is a combination of the LBS_G and the LBS_D, and the equation of the LBS is as follows:

LBS=Σ_{P=1}⁴S(gₚ−gₘₑₐₙ)2^{p+3}+Σ_{P=1}⁴S(dₚ−d_{global})2^{p-1} (3)

In the meanwhile, although the occurrence frequency of the sharp edge mode in the image is relatively low, the sharp edge mode plays an important role in recovery of encoding distortion information of the image, because the human visual system is very sensitive to the sharp edges. The SES is defined in this example:

SES=Σ_{P=1}⁴S(dₚ−t)2^{p-1} (4)

in which, t represents a preset gray threshold; and in one specific embodiment, t is preset to be a relatively large threshold for discriminating a sharp edge.

In a specific embodiment, the training of the texture dictionaries can be accomplished by a k-means clustering mode to yield incomplete dictionaries, or the training of the texture dictionaries can be accomplished by a sparse coding mode to yield over-complete dictionaries.

When the k-means clustering mode is adopted to train the dictionary, a certain amount (for example, one hundred thousand) samples are selected from feature samples. A plurality of class centers are clustered using the k-means clustering algorithm and used as the texture dictionary database. The use of the k-means clustering mode for training the dictionaries is able to establish the incomplete dictionaries with low dimensions.

When the sparse coding mode is adopted to train the dictionaries, the following optimized equation is utilized:

$$D = arg \begin{matrix}min \\ D , Z\end{matrix} {‖ X - DZ ‖}_{2}^{2} + λ {‖ Z ‖}_{1}$$

in which, D represents the dictionaries acquired from the training, X represents a clear image, λ is a preset coefficient and can be an empirical value, L1 norm is a sparsity constraint, L2 norm is a similarity constraint between a dictionary-reconstructed local block and a local block of a training sample. In training the dictionary, D is first fixed and linear programming is utilized to calculate Z; Z is then fixed, quadratic programming is utilized to calculate an optimized D and update D; and the above process is repeated and iterated until that the training of the dictionary D satisfies a termination condition that the error of the dictionaries obtained from the training are within a permitted range.

When the encoding distortion information of the decoded and reconstructed image in the previous frame of the current image frame is recovered using the texture dictionary database to obtain the image with the recovered encoding distortion information, that is, the reconstructed clear image is utilized as a reference image, and an unknown clear local block x can be represented by a combination of multiple dictionary bases:

X≈Dh(y)α (5)

in which, Dₕ(y) represents a clear local block dictionary having the same specific classification of local structure classification (that is, the LBS and the SES classifications) as a quantizing distortion local block y, and α represents an expression coefficient.

When the coefficient α satisfies the sparsity in using the over-complete dictionary, the quantizing distortion local block dictionary Dl(y) is used to calculate the sparse expression coefficient α, then the expression coefficient α is put into the equation (6) to calculate the corresponding clear local block x. Thus, the acquisition of the optimized α can be converted into the following optimization problem:

min∥α∥₀s.t.∥FD₁α−Fy∥₂²≦ε (7)

in which, ε is a minimum value approaching 0, F represents an operation of extracting local block features of the image, and in the dictionary D provided in this example, the extracted features are a combination of a local gray difference and a gradient value. Because α is sparse enough, an L1 norm is adopted to substitute an L0 norm in the equation (9), then the optimization problem is converted into the following:

$$\begin{matrix}min \\ α\end{matrix} {‖ {FD}_{1} α - Fy ‖}_{2}^{2} + λ {‖ α ‖}_{1} \qquad ( 8 )$$

in which, λ represents a coefficient regulating the sparsity and the similarity. The optimized sparse expression coefficient α can be acquired by solving the above Lasso problem, then the optimized sparse expression coefficient α is put into the equation (6) to calculate the clear local image block X corresponding to y.

When a does not satisfy the sufficient sparsity in using the incomplete dictionary, the K-nearest neighbor algorithm is used to find λ dictionary bases Dl(y) that are most resembles y, then linear combinations of λ clear dictionaries Dh(y) corresponding to the Dl(y) are adopted to reconstruct x.

When all the clear image blocks x corresponding to each quantizing distortion local blocks y in the image are reconstructed, the final clear image is restored.

S103: performing temporal prediction according to the reference image to obtain the prediction blocks of the image blocks to be encoded.

S104: performing subtraction between the image blocks to be encoded and the prediction blocks to obtain residual blocks. After S102, the reference image much resembles the original image, and the prediction blocks of the image blocks to be encoded acquired according to the reference image also much resemble the original image, so that the redundancy of the residual blocks is much smaller, and the encoding efficiency is improved.

S105: processing the residual blocks to obtain a video bit stream. Specifically, the residual blocks are transformed, quantized, and entropy encoded to obtain the video bit stream. In the above video encoding method, the encoding distortion information of the decoded and reconstructed image in the previous frame of the current image frame is recovered using the texture dictionary database, and the temporal prediction is then performed using the image with the recovered encoding distortion information as the reference image to obtain the prediction blocks of the image blocks to be encoded. The encoding method is capable of recovering the encoding distortion information of the reference image to make the prediction blocks of the image blocks to be encoded more accurate, thus improving the encoding efficiency.

### Example 2

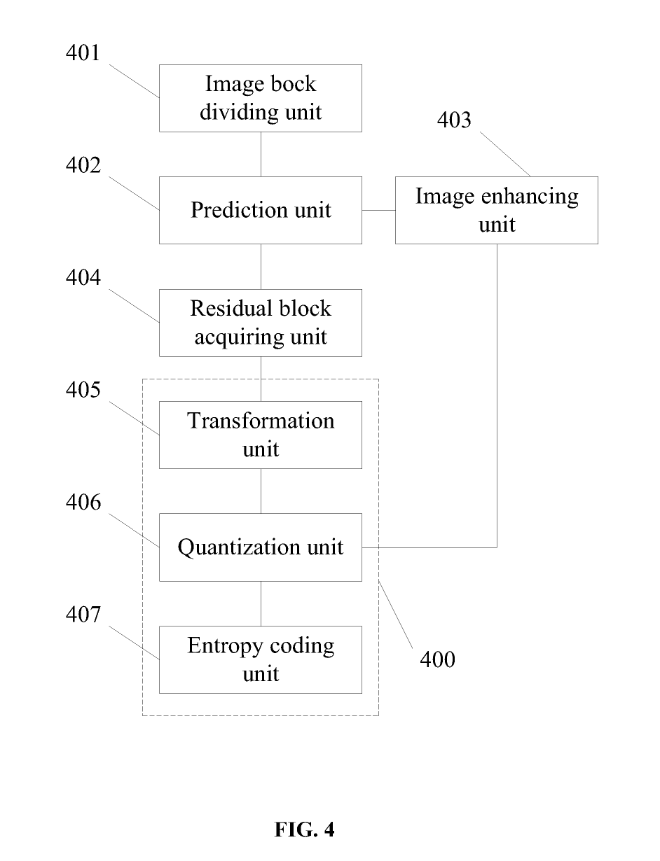

As shown in FIG. 4, a device for video encoding based on a dictionary database is provided based on the above video encoding method. The device comprises: an image bock dividing unit 401, an image enhancing unit 402, a prediction unit 403, a residual block acquiring unit 404, and a processing unit 400.

The image block dividing unit 401 is configured to divide a current image frame to be encoded in a video stream into a plurality of image blocks.

The image enhancing unit 402 is configured to recover encoding distortion information of a decoded and reconstructed image of a previous frame of the current image frame using a texture dictionary database to obtain an image with recovered encoding distortion information, and adopt the image with the recovered encoding distortion information as a reference image. The texture dictionary database comprises: clear image dictionaries and distorted image dictionaries corresponding to the clear image dictionaries;

The prediction unit 403 is configured to perform temporal prediction on image bocks to be encoded according to the reference image to obtain prediction blocks of the image blocks to be encoded.

The residual block acquiring unit 404 is configured to perform subtraction between the image blocks to be encoded and the prediction blocks to obtain residual blocks.

The processing unit 400 is configured to process the residual blocks to obtain a video bit stream.

In one specific embodiment, the processing unit 400 comprises: a transformation unit 405, a quantization unit 406, and an entropy coding unit 407. The transformation unit 405 is configured to transform the residual blocks. The quantization unit 406 is configured to quantize the residual blocks after transformation. The entropy coding unit 407 is configured to entropy code the residual blocks after quantization so as to obtain the video bit stream.

In one specific embodiment, the encoding device further comprises a texture dictionary training unit configured to select local blocks in a clear image and corresponding local blocks in a quantizing distorted image of the clear image, and extract feature pairs of the local blocks in the clear image and the corresponding local blocks in the quantizing distorted image so as to form the clear image dictionaries and the distorted image dictionaries. In other embodiments, the texture dictionary can be pre-trained.

The texture dictionary training unit adopts a k-means clustering mode to train the texture dictionary database to yield incomplete dictionaries; or the texture dictionary training unit adopts a sparse coding mode to train the texture dictionary database to yield over-complete dictionaries.

When the texture dictionary training unit adopts the sparse coding mode to train the dictionaries, the following optimized equation is adopted:

$$D = arg \begin{matrix}min \\ D , Z\end{matrix} {‖ X - DZ ‖}_{2}^{2} + λ {‖ Z ‖}_{1}$$

in which, D represents the dictionaries acquired from training, X represents a clear image, λ is a preset coefficient, L1 norm is a sparsity constraint, L2 norm is a similarity constraint between a dictionary-reconstructed local block and a local block of a training sample. In training the dictionary, D is first fixed and linear programming is utilized to calculate Z; Z is then fixed, quadratic programming is utilized to calculate an optimized D and update D; and the above process is repeated and iterated until that the training of the dictionary D satisfies a termination condition that the error of the dictionaries obtained from the training are within a permitted range.

In the above video encoding device, the encoding distortion information of the decoded and reconstructed image in the previous frame of the current image frame is recovered using the texture dictionary database, and the temporal prediction is then performed using the image with the recovered encoding distortion information as the reference image to obtain the prediction blocks of the image blocks to be encoded. The encoding device is capable of recovering the encoding distortion information of the reference image to make the prediction blocks of the image blocks to be encoded more accurate, thus improving the encoding efficiency.

### Example 3

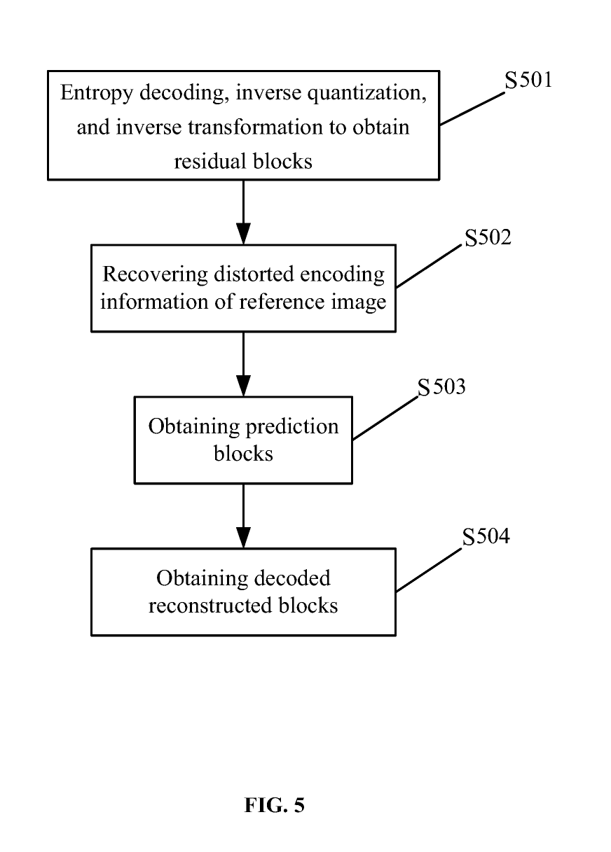

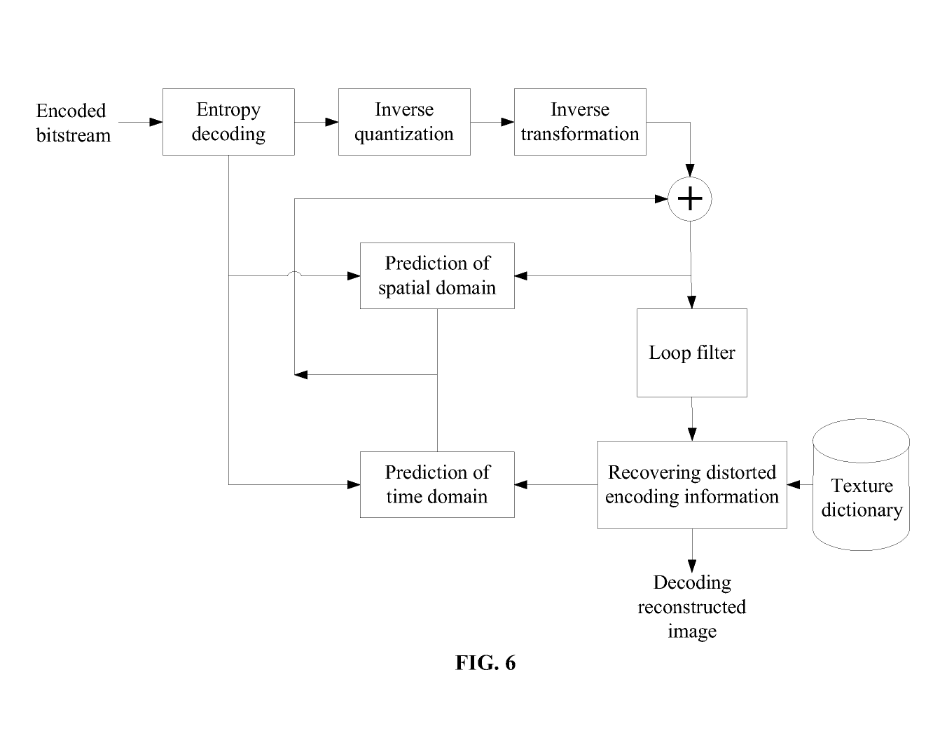

As shown in FIGS. 5-6, FIG. 5 is a flow chart of a method for video decoding based on a dictionary database, and FIG. 6 is a block diagram of the method for video decoding based on the dictionary database. The method for video decoding based on the dictionary database is provided corresponding to the video encoding method of Example 1. The video decoding method comprises:

S501: processing an acquired video bit stream to obtain residual blocks of image blocks to be decoded of a current image frame to be decoded. Specifically, the video bit stream acquired is processed with entropy decoding, inverse quantization, and inverse transformation to obtain the residual blocks.

S502: recovering encoding distortion information of a decoded and reconstructed image of a previous frame of the current image frame using a texture dictionary database to obtain an image with recovered encoding distortion information, and using the image with the recovered encoding distortion information as a reference image;

S503: performing temporal prediction according to the reference image to obtain prediction blocks of image blocks to be decoded; and

S504: adding the prediction blocks of the image blocks to be decoded to the residual blocks to obtain the decoded reconstructed blocks of the image blocks to be decoded.

The training of the texture dictionaries is the same as that of Example 1, and therefore won't be repeated herein.

In the video decoding method of this example, the encoding distortion information of the decoded and reconstructed image in the previous frame of the current image frame is recovered using the texture dictionary database, and the temporal prediction is then performed using the image with the recovered encoding distortion information as the reference image to obtain the prediction blocks of the image blocks to be decoded. The decoding method is capable of recovering the encoding distortion information of the reference image to make the prediction blocks of the image blocks to be decoded more accurate, thus improving the decoding efficiency.

### Example 4

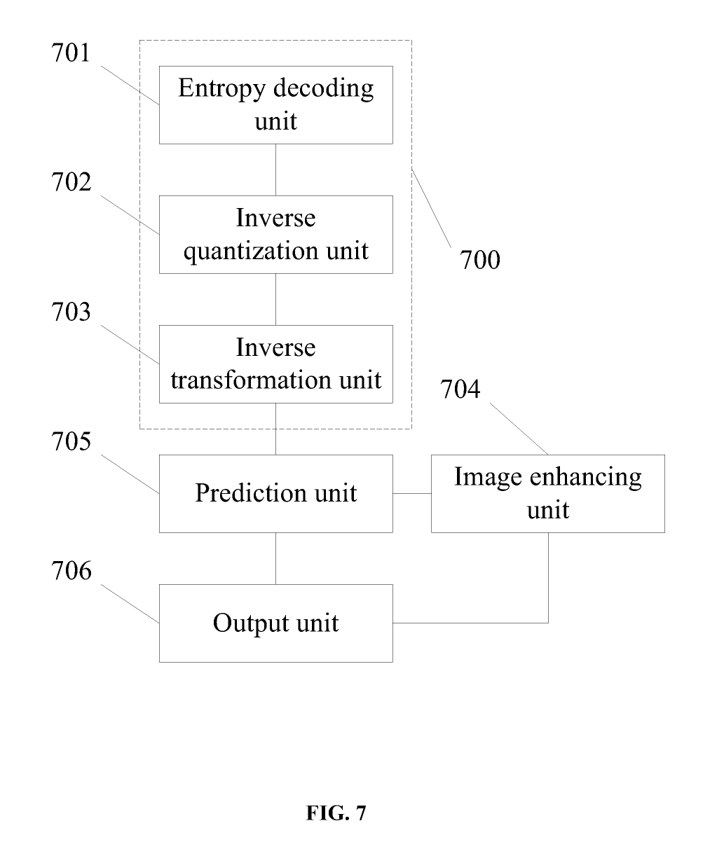

As shown in FIG. 7, a device for video decoding based on a dictionary database is provided according to the method of Example 3. The device for video decoding comprises: a processing unit 700, an image enhancing unit 704, a prediction unit 705, and an output unit 706.

The processing unit 700 is configured to process an acquired video bit stream to obtain residual blocks of image blocks to be decoded of a current image frame to be decoded. Specifically, the processing unit 700 comprises an entropy decoding unit 701, an inverse quantization unit 702, and inverse transformation unit 703. The inverse quantization unit 702 is used to inversely quantize the video bit stream after the entropy decoding. The inverse transformation unit 703 is used to inversely transform the video bit stream after the inverse quantization so as to obtain the residual blocks.

The image enhancing unit 704 is configured to recover encoding distortion information of a decoded and reconstructed image of a previous frame of the current image frame using a texture dictionary database to obtain an image with recovered encoding distortion information, and adopt the image with the recovered encoding distortion information as a reference image. The texture dictionary database comprises: clear image dictionaries and distorted image dictionaries corresponding to the clear image dictionaries.

The prediction unit 705 is configured to perform temporal prediction according to the reference image to obtain prediction blocks of image blocks to be decoded.

The output unit 706 is configured to add the prediction blocks to the corresponding residual blocks to obtain the decoded reconstructed blocks of the image blocks to be decoded.

In the video decoding device of this example, the encoding distortion information of the decoded and reconstructed image in the previous frame of the current image frame is recovered using the texture dictionary database, and the temporal prediction is then performed using the image with the recovered encoding distortion information as the reference image to obtain the prediction blocks of the image blocks to be decoded. The decoding device is capable of recovering the encoding distortion information of the reference image to make the prediction blocks of the image blocks to be decoded more accurate, thus improving the decoding efficiency.

It can be understood by the skills in the technical field that all or partial steps in the methods of the above embodiments can be accomplished by controlling relative hardware by programs. These programs can be stored in readable storage media of a computer, and the storage media include: read-only memories, random access memories, magnetic disks, and optical disks.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for video encoding based on a dictionary database, the method comprising:
1) dividing a current image frame to be encoded in a video stream into a plurality of image blocks;
2) recovering encoding distortion information of a decoded and reconstructed image of a previous frame of the current image frame using a texture dictionary database to obtain an image with recovered encoding distortion information, and performing temporal prediction using the image with the recovered encoding distortion information as a reference image to obtain prediction blocks of image blocks to be encoded; wherein the texture dictionary database comprises: clear image dictionaries and distorted image dictionaries corresponding to the clear image dictionaries; and
3) performing subtraction between the image blocks to be encoded and the prediction blocks to obtain residual blocks, and processing the residual blocks to obtain a video bit stream.

2. The method of claim 1, wherein recovery of the encoding distortion information of the decoded and reconstructed image in the previous frame of the current image frame using the texture dictionary database to obtain the image with the recovered encoding distortion information specifically comprises:
matching the decoded and reconstructed image with the texture dictionaries based on local features of image blocks so as to obtain the image with the recovered encoding distortion information; and
the local features of the image blocks comprise: local gray differences, gradient values, local texture structures, and texture structure information of neighboring image blocks.

3. The method of claim 2, wherein matching the decoded and reconstructed image with the texture dictionary based on the local features of the image blocks so as to obtain the image with the recovered encoding distortion information specifically comprises: adopting the following reconstruction equation to obtain clear local blocks whereby further acquiring the image with the recovered encoding distortion information: x≈Dₕ(y)a, in which, x represents an unknown clear local block, y represents a quantizing distorted local block corresponding to the clear local block, Dₕ(y) represents a trained clear local block dictionary, and a represents an expression coefficient.

4. The method of claim 3, wherein the expression coefficient α satisfies the following constraint condition:
min∥α∥₀s.t.∥FD₁α−Fy∥₂²≦ε
in which, ε is a minimum value approaching 0, F represents an operation of extracting local block features of the image, and D₁ represents a trained distorted image dictionary.

5. The method of claim 1, wherein training of the texture dictionary database comprises: selecting local blocks in a clear image; selecting corresponding local blocks in a quantizing distorted image of the clear image; and extracting feature pairs of the local blocks in the clear image and the corresponding local blocks in the quantizing distorted image for training the clear image dictionaries and the distorted image dictionaries.

6. The method of claim 2, wherein training of the texture dictionary database comprises: selecting local blocks in a clear image; selecting corresponding local blocks in a quantizing distorted image of the clear image; and extracting feature pairs of the local blocks in the clear image and the corresponding local blocks in the quantizing distorted image for training the clear image dictionaries and the distorted image dictionaries.

7. The method of claim 5, wherein the texture dictionary database is trained by a k-means clustering mode to yield incomplete dictionaries; or the texture dictionary database is trained by a sparse coding mode to yield over-complete dictionaries.

8. The method of claim 6, wherein the texture dictionary database is trained by a k-means clustering mode to yield incomplete dictionaries; or the texture dictionary database is trained by a sparse coding mode to yield over-complete dictionaries.

9. The method of claim 7, wherein when using the sparse coding mode to train the dictionaries, the following optimized equation is adopted:
$$D = arg \begin{matrix}min \\ D , Z\end{matrix} {‖ X - DZ ‖}_{2}^{2} + λ {‖ Z ‖}_{1}$$
in which, D represents the dictionaries acquired from training, X represents a clear image, λ is a preset coefficient, L1 norm is a sparsity constraint, L2 norm is a similarity constraint between a dictionary-reconstructed local block and a local block of a training sample; and
in training the dictionary, D is first fixed and linear programming is utilized to calculate Z; Z is then fixed, quadratic programming is utilized to calculate an optimized D and update D; and the above process is repeated and iterated until that the training of the dictionary D satisfies a termination condition.

10. The method of claim 8, wherein when using the sparse coding mode to train the dictionaries, the following optimized equation is adopted:
$$D = arg \begin{matrix}min \\ D , Z\end{matrix} {‖ X - DZ ‖}_{2}^{2} + λ {‖ Z ‖}_{1}$$
in which, D represents the dictionaries acquired from training, X represents a clear image, λ is a preset coefficient, L1 norm is a sparsity constraint, L2 norm is a similarity constraint between a dictionary-reconstructed local block and a local block of a training sample; and
in training the dictionary, D is first fixed and linear programming is utilized to calculate Z; Z is then fixed, quadratic programming is utilized to calculate an optimized D and update D; and the above process is repeated and iterated until that the training of the dictionary D satisfies a termination condition.

11. A method for video decoding based on a dictionary database, the method comprising:
1) processing an acquired video bit stream to obtain residual blocks of image blocks to be decoded of a current image frame to be decoded;
2) recovering encoding distortion information of a decoded and reconstructed image of a previous frame of the current image frame using a texture dictionary database to obtain an image with recovered encoding distortion information, and performing temporal prediction using the image with the recovered encoding distortion information as a reference image to obtain prediction blocks of image blocks to be decoded; wherein the texture dictionary database comprises: clear image dictionaries and distorted image dictionaries corresponding to the clear image dictionaries; and
3) adding the prediction blocks to the corresponding residual blocks to obtain the decoded reconstructed blocks of the image blocks to be decoded.

12. A device for video encoding based on a dictionary database, the device comprising:
a) an image block dividing unit configured to divide a current image frame to be encoded in a video stream into a plurality of image blocks;
b) an image enhancing unit configured to recover encoding distortion information of a decoded and reconstructed image of a previous frame of the current image frame using a texture dictionary database to obtain an image with recovered encoding distortion information, and adopt the image with the recovered encoding distortion information as a reference image; wherein the texture dictionary database comprises: clear image dictionaries and distorted image dictionaries corresponding to the clear image dictionaries;
c) a prediction unit configured to perform temporal prediction according to the reference image to obtain prediction blocks of image blocks to be encoded;
d) a residual block acquiring unit configured to perform subtraction between the image blocks to be encoded and the prediction blocks to obtain residual blocks; and
e) a processing unit configured to process the residual blocks to obtain a video bit stream.

13. The device of claim 12, wherein
the image enhancing unit recovers the encoding distortion information of the decoded and reconstructed image in the previous frame of the current image frame using the texture dictionary database to obtain an image with recovered encoding distortion information, the image enhancing unit matches the decoded and reconstructed image with the texture dictionaries based on local features of image blocks so as to obtain the image with the recovered encoding distortion information; and
the local features of the image blocks comprise: local gray differences, gradient values, local texture structures, and texture structure information of neighboring image blocks.

14. The device of claim 13, wherein when the image enhancing unit matches the decoded and reconstructed image with the texture dictionary based on the local features of the image blocks, the following reconstruction equation is adopted to obtain clear local blocks whereby further acquiring the image with the recovered encoding distortion information: x≈Dₕ(y)a, in which, x represents an unknown clear local block, y represents a quantizing distorted local block corresponding to the clear local block, Dₕ(y) represents a trained clear local block dictionary, and a represents an expression coefficient.

15. The device of claim 14, wherein the expression coefficient α satisfies the following constraint condition:
min∥α∥₀s.t.∥FD₁α−Fy∥₂²≦ε
in which, ε is a minimum value approaching 0, F represents an operation of extracting local block features of the image, and D1 represents a trained distorted image dictionary.

16. The device of claim 12, further comprising: a texture dictionary training dictionary configured to select local blocks in a clear image and corresponding local blocks in a quantizing distorted image of the clear image, and extract feature pairs of the local blocks in the clear image and the corresponding local blocks in the quantizing distorted image so as to train the clear image dictionaries and the distorted image dictionaries.

17. The device of claim 13, further comprising: a texture dictionary training dictionary configured to select local blocks in a clear image and corresponding local blocks in a quantizing distorted image of the clear image, and extract feature pairs of the local blocks in the clear image and the corresponding local blocks in the quantizing distorted image so as to train the clear image dictionaries and the distorted image dictionaries.

18. The device of claim 13, wherein the texture dictionary training unit adopts a k-means clustering mode to train the texture dictionary database to yield incomplete dictionaries; or the texture dictionary training unit adopts a sparse coding mode to train the texture dictionary database to yield over-complete dictionaries.

19. The device of claim 14, wherein
when the texture dictionary training unit adopts the sparse coding mode to train the dictionaries, the following optimized equation is adopted:
$$D = arg \begin{matrix}min \\ D , Z\end{matrix} {‖ X - DZ ‖}_{2}^{2} + λ {‖ Z ‖}_{1}$$
in which, D represents the dictionaries acquired from training, X represents a clear image, λ is a preset coefficient, L1 norm is a sparsity constraint, L2 norm is a similarity constraint between a dictionary-reconstructed local block and a local block of a training sample; and
in training the dictionary, D is first fixed and linear programming is utilized to calculate Z; Z is then fixed, quadratic programming is utilized to calculate an optimized D and update D; and the above process is repeated and iterated until that the training of the dictionary D satisfies a termination condition.

20. A device for video decoding based on a dictionary database, the device comprising:
a) a processing unit configured to process an acquired video bit stream to obtain residual blocks of image blocks to be decoded of a current image frame to be decoded;
b) an image enhancing unit configured to recover encoding distortion information of a decoded and reconstructed image of a previous frame of the current image frame using a texture dictionary database to obtain an image with recovered encoding distortion information, and adopt the image with the recovered encoding distortion information as a reference image; wherein the texture dictionary database comprises: clear image dictionaries and distorted image dictionaries corresponding to the clear image dictionaries;
c) a prediction unit configured to perform temporal prediction according to the reference image to obtain prediction blocks of image blocks to be decoded; and
d) an output unit configured to add the prediction blocks to the corresponding residual blocks to obtain the decoded reconstructed blocks of the image blocks to be decoded.
